(19) United States
(12) Patent Application Publication
(10) Pub. No.: US 2002/0029505 A1
(43) Pub. Date: Mar. 14, 2002

(54) Shelf display clip

(75) Inventor: Daniel Faneuf, Milford, NH (US)

Correspondence Address: Norman P. Soloway, HAYES, SOLOWAY, HENNESSEY,, GROSSMAN & HAGE, P.C., 175 Canal Street, Manchester, NH, 03101, US

(73) Assignee: Plasti-Clip Corporation

(21) Appl. No.: 09/836,032

(22) Filed: Apr. 17, 2001

Related U.S. Application Data
(60) Provisional application No. 60/198,459, filed on Apr. 19, 2000.

(51) Int. Cl. G09F 3/20

(52) U.S. Cl. 40/658

(57) ABSTRACT

A clip for displaying cards is disclosed that has a plurality of protrusions for gripping the card disposed between a plurality of wall portions. Insertion of the card between the wall portions deflects the protrusions. The protrusions need not extend the length of the clip nor do they need to be linear. The protrusions can be intermittent and/or be at an angle to a longitudinal axis of the clip.

### CROSS-REFERENCE TO RELATED APPLICATIONS

This application claims the benefit of copending U.S. provisional patent application serial No. 60/198,459 filed Apr. 19, 2000, the teachings of which are incorporated herein by reference.

### FIELD OF THE INVENTION

The present invention relates to an improved clip for use in holding a display card in conjunction with a grocery shelf or the like, and more specifically to an injection-molded plastic clip which engages into the molding track of a grocery shelf and holds a display card such as a price card or advertisement in place.

### BACKGROUND OF THE INVENTION

Clips for holding display cards on the molding track of grocery shelves are well known in the art. Clips of various materials and design are fashioned to engage with the molding tracks of the typical grocery shelf. Such clips have various means of holding a display card in place to show pricing and/or advertisement of a featured item on the shelf. The clips are usually fairly easy to remove from the shelf molding, and the display cards can easily be inserted in or removed from the clip. Some of such clips have been made of extruded plastic; for example, U.S. Pat. No. 4,557,064 to Thompson discloses an extruded plastic clip that has a clipping portion with co-extruded resilient plastic fins for gripping the display card.

One type of clip known in the art is of two-piece construction, with the first piece having a clipping portion like that disclosed in Thompson with co-extruded resilient plastic fins, and a separately extruded second piece comprising the base portion which engages in the shelf molding track. The two pieces are then assembled to form clip assemblies as shown in Figs 1A, 1B and 1C.

Although the prior-art clips shown in FIGS. 1A, 1B and 1C are of a convenient design, they present several disadvantages. One disadvantage lies in the necessity for the extruded pieces to be die-cut, resulting in sharp edges that are problematic for the assembler and by the end-user. In addition, the process of die-cutting the extruded components builds in stress, increasing the likelihood of breakage. A further disadvantage is that the components must be assembled, making the clip more costly to produce. Moreover, the assembly process itself not only increases the likelihood of breakage during assembly, but also may impose further mechanical stress on the components, which may result in breakage or failure during use.

### SUMMARY OF THE INVENTION

The shelf display clip of the present invention, as shown in the several attached drawing FIGS. 2-38, overcomes the disadvantages of prior-art clips while providing several additional advantages by providing an improved shelf display clip which is of one-piece, injection, compression, or transfer molded construction. The improved clip is stronger than prior-art clips and is less expensive to manufacture. The one-piece construction eliminates the need for assembly. The injection-molding process enables the clip to be molded with a clipping portion having resilient protrusions of several embodiments for gripping a display card inserted therein. The protrusions need not extend the length of the clip nor need they be linear; they may be intermittent and/or angular to the longitudinal axis of the clipping portion. The clip may also be manufactured with other advantageous features, such as finger grips, which may be of resilient material, and one or more side ribs for structural support and added gripping power of the clipping portion. In addition, the improved clip may be molded with rounded edges to minimize cuts and scrapes to personnel working with the clips.

### BRIEF DESCRIPTION OF THE DRAWINGS

FIGS. 1A-C show a prior art display clip.

FIG. 2 is a top view of a first embodiment of a rigid portion of a clip made in accordance with the present invention.

FIG. 3 is an isometric view of the rigid portion of FIG. 2.

FIG. 4 is a front view of the rigid portion of FIG. 2.

FIG. 5 is a right side view of the rigid portion of FIG. 2.

FIG. 6 is a left side view of a first embodiment resilient portion of a clip made in accordance with the present invention.

FIG. 7 is a front view of the resilient portion of FIG. 6.

FIG. 8 is a right side view of the resilient portion of FIG. 6.

FIG. 9 is an isometric view of the resilient portion of FIG. 6.

FIG. 10 is a partial enlarged view of FIG. 6.

FIG. 11 is a left side view of a second embodiment resilient portion of a clip made in accordance with the present invention.

FIG. 12 is a front view of the resilient portion of FIG. 11.

FIG. 13 is a right side view of the resilient portion of FIG. 11.

FIG. 14 is an isometric view of the resilient portion of FIG. 11.

FIG. 15 is a partial enlarged view of FIG. 11.

FIG. 16 is an exploded isometric view of a first embodiment clip made in accordance with the present invention.

FIG. 17 is an isometric view of the clip of FIG. 16.

FIG. 18 is a top view of a second embodiment clip made in accordance with the present invention.

FIG. 19 is an isometric view of the clip of FIG. 18 taken at a first angle.

FIG. 20 is a front view of the clip of FIG. 18.

FIG. 21 is a right side view of the clip of FIG. 18.

FIG. 22 is an isometric section view of the clip of FIG. 18 taken through line 22-22 of FIG. 21.

FIG. 23 is an isometric view of the clip of FIG. 18 taken at a second angle.

FIG. 24 is an isometric view of the clip of FIG. 18 taken at a third angle.

FIG. 25 is an isometric view of a third embodiment clip made in accordance with the present invention.

FIG. 26 is a profile view of a protrusion of the resilient portion of the clip of FIG. 25.

FIG. 27 is an isometric view of a fourth embodiment clip made in accordance with the present invention.

FIG. 28 is a profile view of a protrusion of the resilient portion of the clip of FIG. 27.

FIG. 29 is an isometric view of fifth embodiment clip made in accordance with the present invention.

FIG. 30 is a profile view of a protrusion of the resilient portion of the clip of FIG. 29.

FIG. 31 is an isometric view of sixth embodiment clip made in accordance with the present invention.

FIG. 32 is a top view of a seventh embodiment clip made in accordance with the present invention.

FIG. 33 is an isometric view of the clip of FIG. 32.

FIG. 34 is an isometric view of a second embodiment rigid portion of a clip made in accordance with the present invention.

FIG. 35 is a profile view of an eighth embodiment clip made in accordance with the present invention.

FIG. 36 is a front view of the clip of FIG. 35.

FIG. 37 is a profile view of a ninth embodiment clip made in accordance with the present invention.

FIG. 38 is a front view of the clip of FIG. 37.

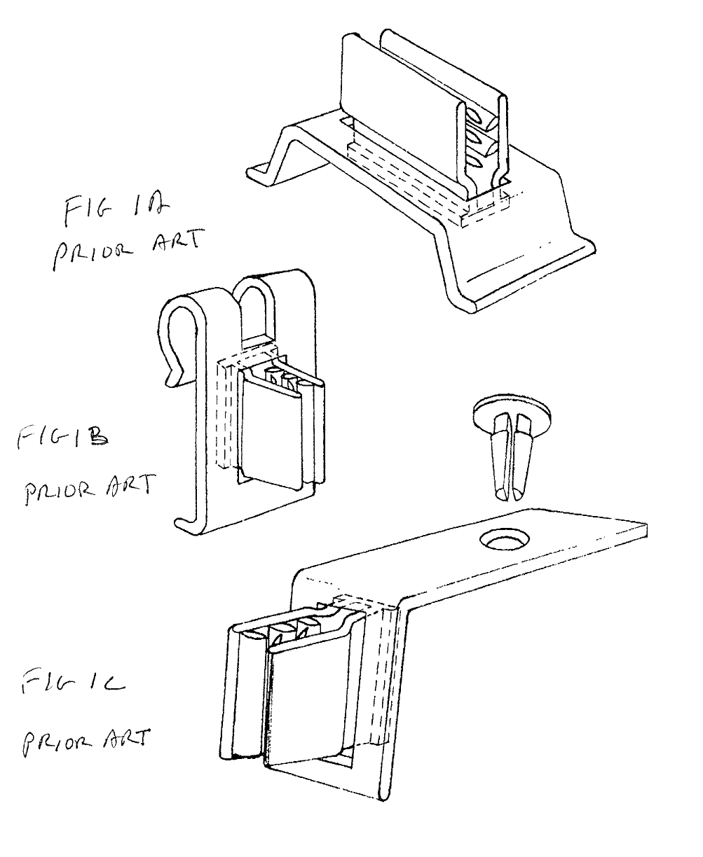

### DETAILED DESCRIPTION OF EMBODIMENTS OF THE INVENTION

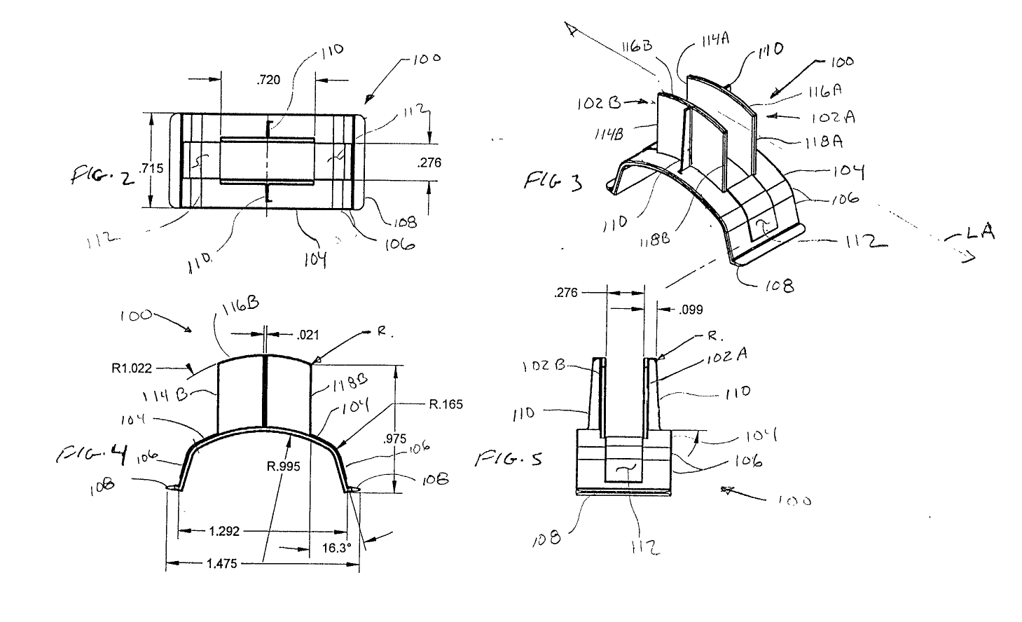

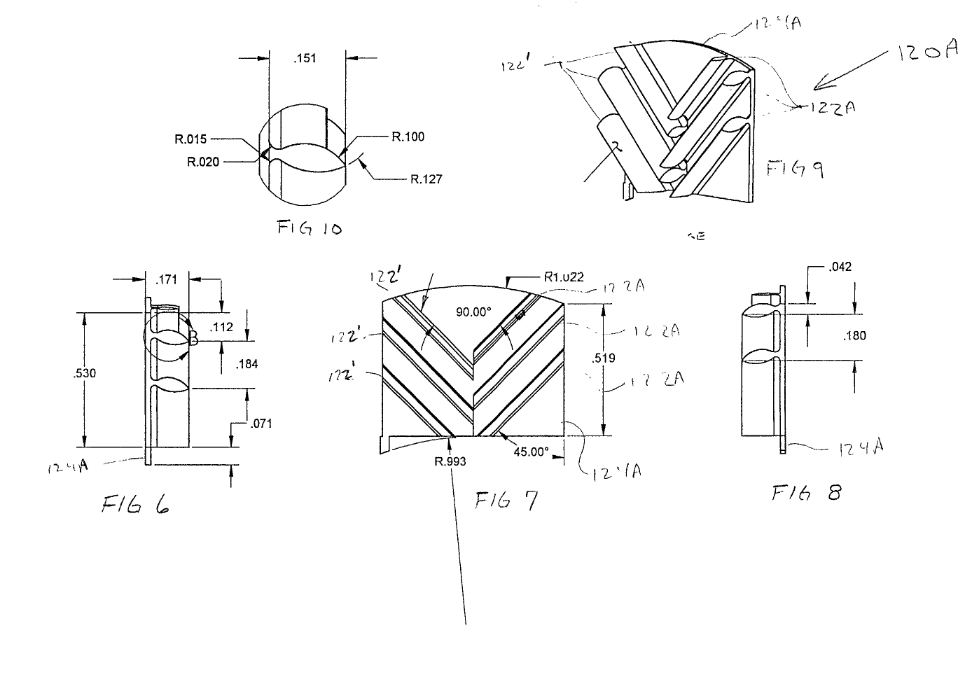

FIGS. 2-5 show several views of a rigid portion 100 of a first embodiment clip 200. The rigid portion 100 may comprise two vertical wall portions 102A and 102B spaced apart for placement of a display card C there between. The wall portions 102A and 102B are shown substantially parallel, i.e. the walls are within 20° of parallel. Coupled to the wall portions 102A and 102B may be a base portion 104 which may comprise two wing portions 106 with flanges 108 which engage in the channels of the molding track of a grocery shelf. Ribs 110 can be added to strengthen the wall portions 102A and 102B. The wing portions 106 are preferably sufficiently flexible to afford easy engagement of the flanges in the molding track when the wing portions are depressed inwardly with finger pressure. The rigid portion of the clip may be formed of a rigid thermoplastic. For purposes of general classification, a rigid plastic has a modulus of elasticity, either in fracture or in tension, greater than 700 Mpa (100,000 PSI) at 23° C. and 50% relative humidity when tested in accordance Test Method D 747, Test Method D 790, Test Method D 638M, or Test Method D 882. Examples of thermoplastics include, but are not limited to polycarbonate, polyester, polyolefins, polyvinyl chloride, acrylonitrile-butadiene-styrene, or styrene-acrylonitrile copolymer or a mixture thereof. The wall portion 102A comprise edges 114A, 116A, and 118A and wall portion 102B comprise edges 114B, 116B, and 118B. The edges 116A and 116B define an opening for insertion of the card C. As shown in FIGS. 3 and 4, the edges 116B and 116A conform to the shape of an arc. Alternatively, the edges 116A and 116B can be any shape including straight. Regardless of the shape of the edges 116A and 116B, the opening is to be understood as a plane parallel with the base portion 104 or flanges 108 that extends between the wall portions.

The wing portion 106 may optionally include a grip portion 112. The grip portion 112 may be integrally formed with the wing potion of a common material or co-injection molded of a different material such as a thermoplastic elastomer (TPE) or thermoplastic polyurethane elastomer (TPU) with the wing portions.

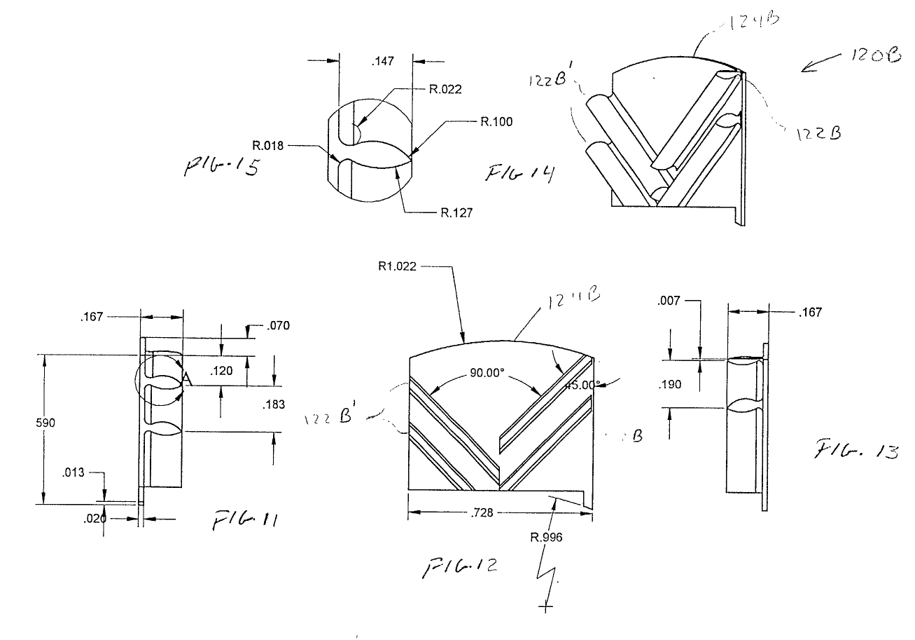

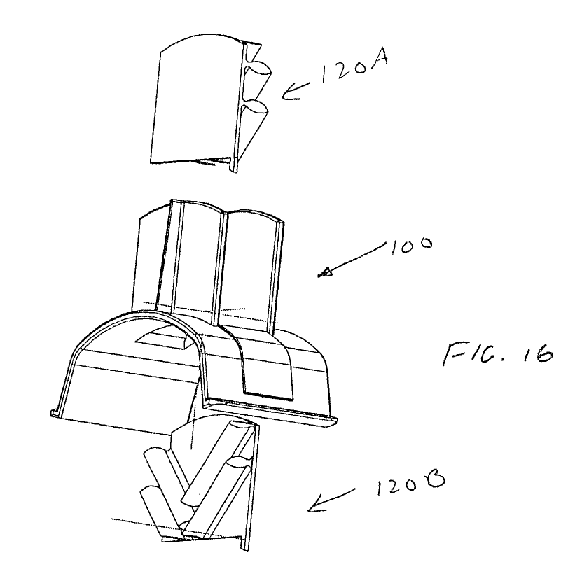

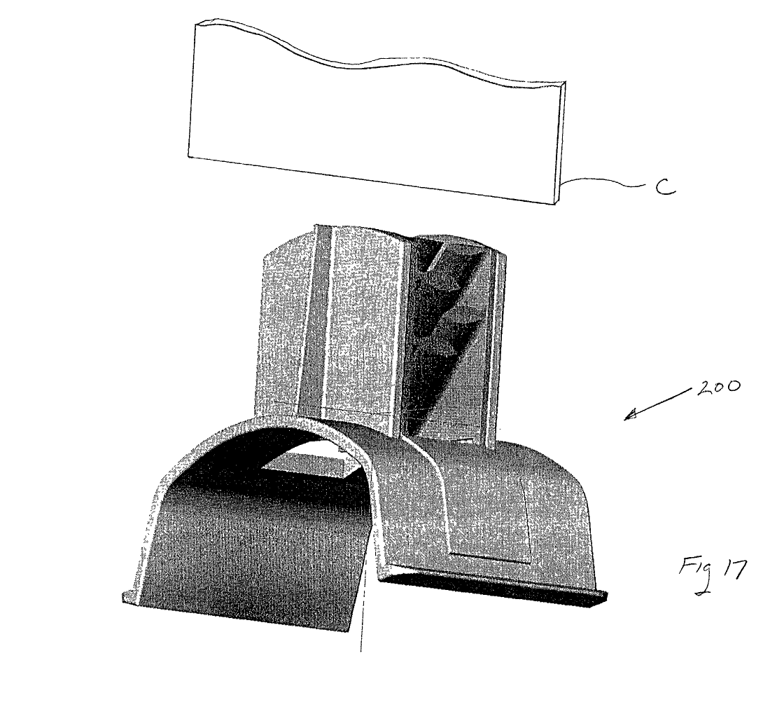

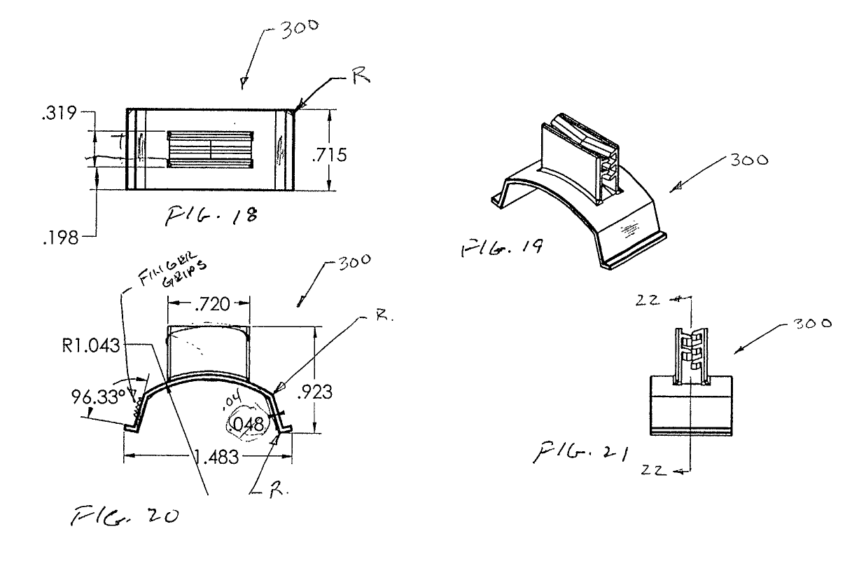

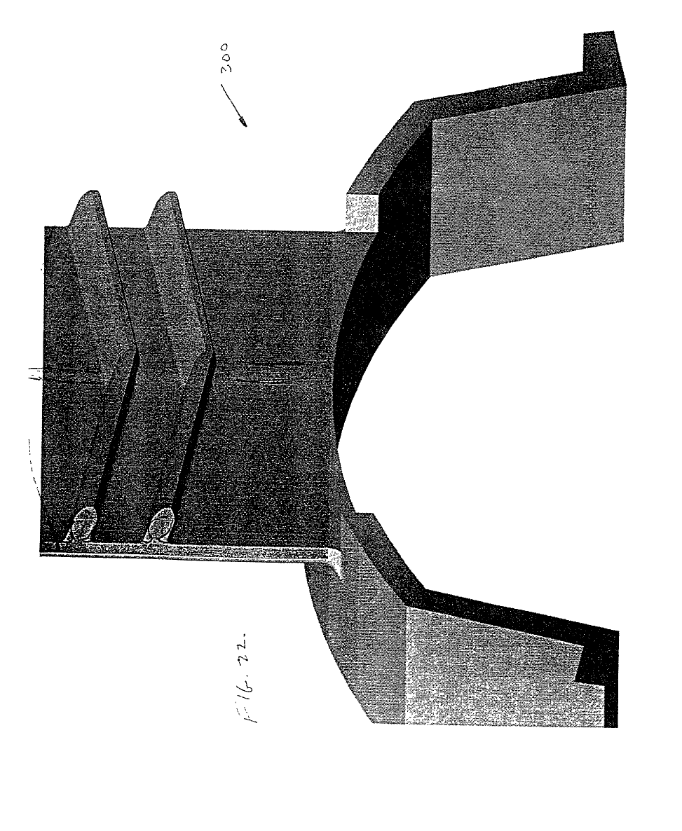

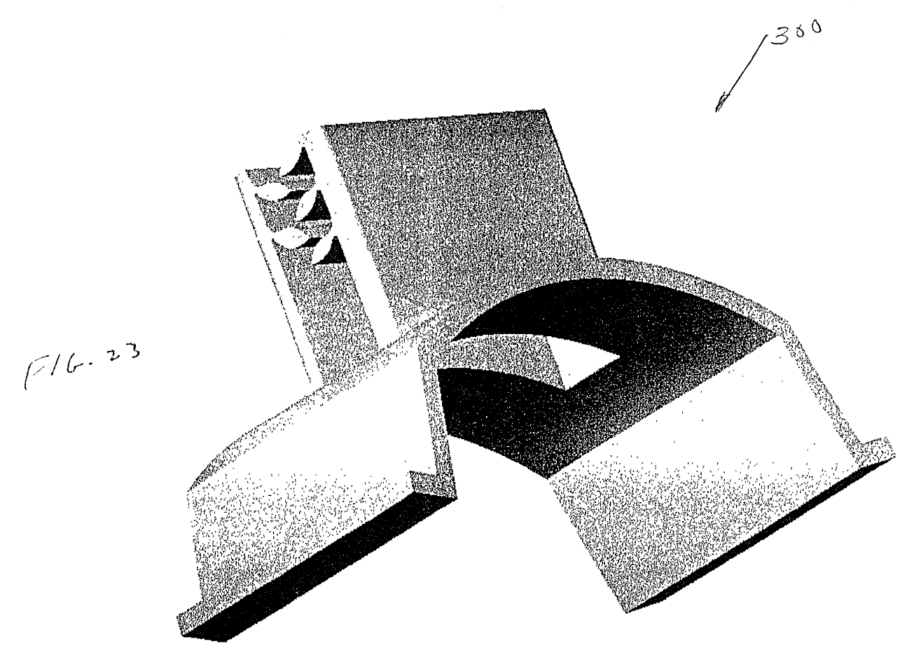

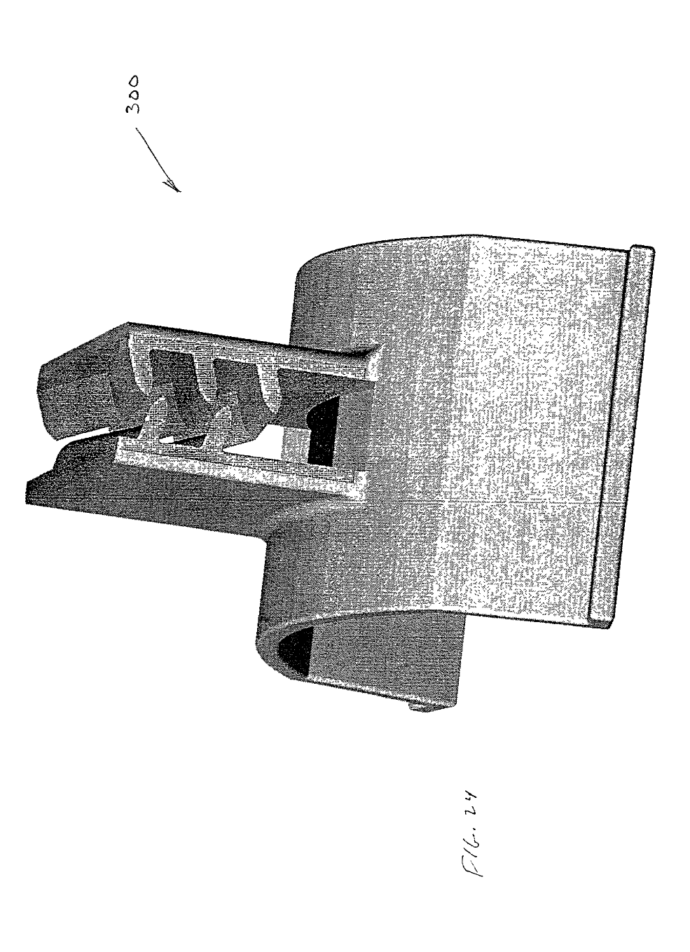

FIGS. 6-10 show several views of a first embodiment resilient portion 120A of the clip 200 and FIGS 11-15 show several views of a second embodiment resilient portion 120B of the clip 200. Preferably, the resilient portions 120 are co-injection molded with the rigid portion 100 to form the clip 200, the resilient portions material and the rigid portion material preferably having different material properties, for example durometer reading or tensile strength. Alternatively, the resilient portion 120 and the rigid portion 100 may be formed separately by injection, compression, or transfer molding and then joined together, for example by adhesively joining or ultrasonically welding. Alternatively, the strength of the rigid portion 100 and the resilient portions 120 can be varied through appropriate part design or a combination of material selection and part design. The increased strength of the rigid portion 100 over the resilient portion can be accomplished by adjusting the thickness of the part in certain areas or by the addition or subtraction of geometric features such as gussets, ribs, and reliefs. For purposes of general classification, a resilient plastic has a modulus of elasticity, either in fracture or in tension, less than 700 Mpa (100,000 PSI) at 23° C. and 50 % relative humidity when tested in accordance Test Method D 747, Test Method D 790, Test Method D 638M, or Test Method D 882. The resilient portions 120A and 120B comprises a plurality of resilient protrusions 122A and 122A′ and 122B and 122B′ coupled to webs 124A and 124B respectively. The protrusions 122 may be formed of TPE, TPU, or other resilient material that can bond directly or mechanically with the rigid portion 100. The protrusions 122 may comprise a variety of shapes. The protrusion 122A and 122B are shown perpendicular to the protrusion 122A′ and 122B′ respectively. The protrusions can be aligned at any angle relative to each other or even inline. The protrusions do not have to extend the entire length of the wall portion 102 (i.e. from edge 114 to 118). The protrusions 122A and 122B may extend inward of the wall portions and stop just shy of the centerline (leaving a gap between the protrusion), at the centerline (no gap), or may extend over the centerline of the opening (the protrusions overlapping each other). As shown in FIGS. 16 and 17, the protrusions 122 may not be parallel with the opening.

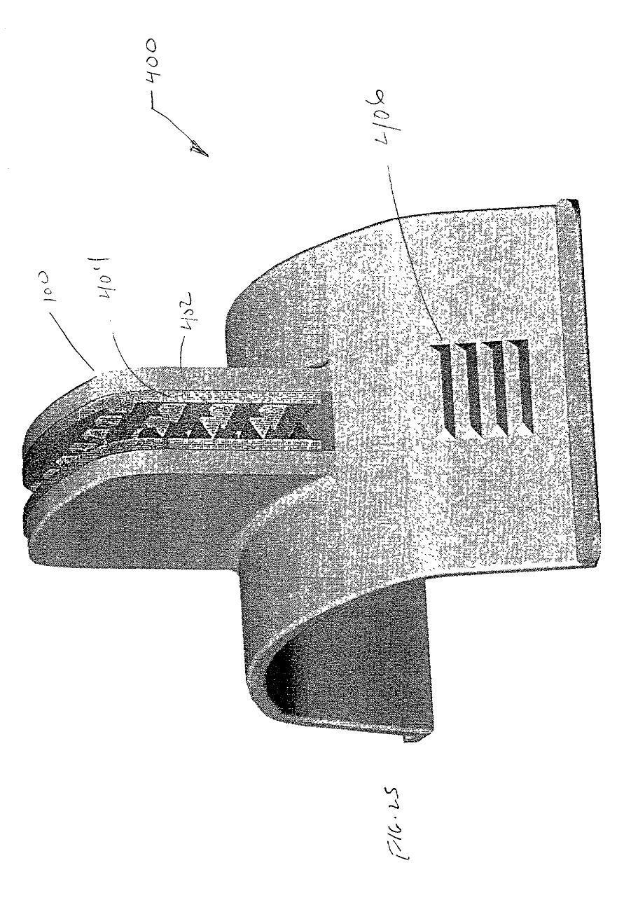

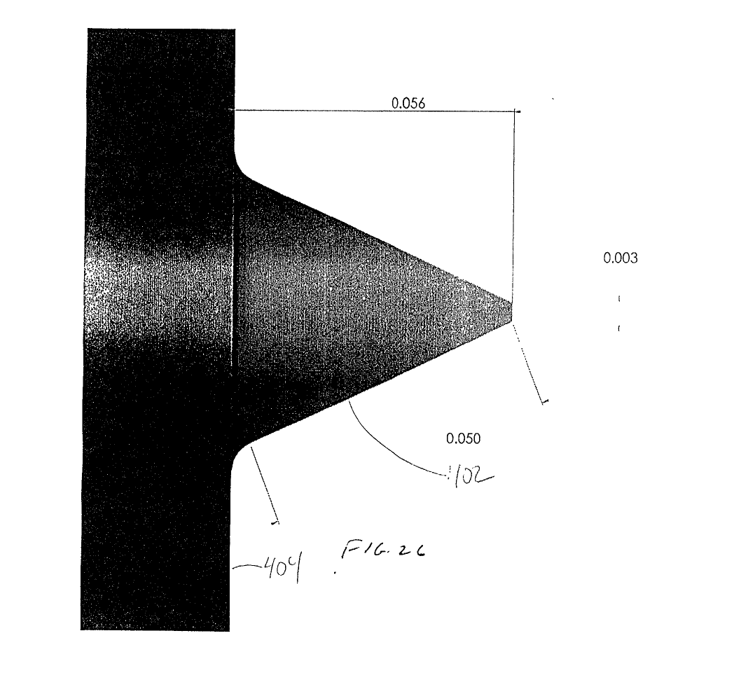

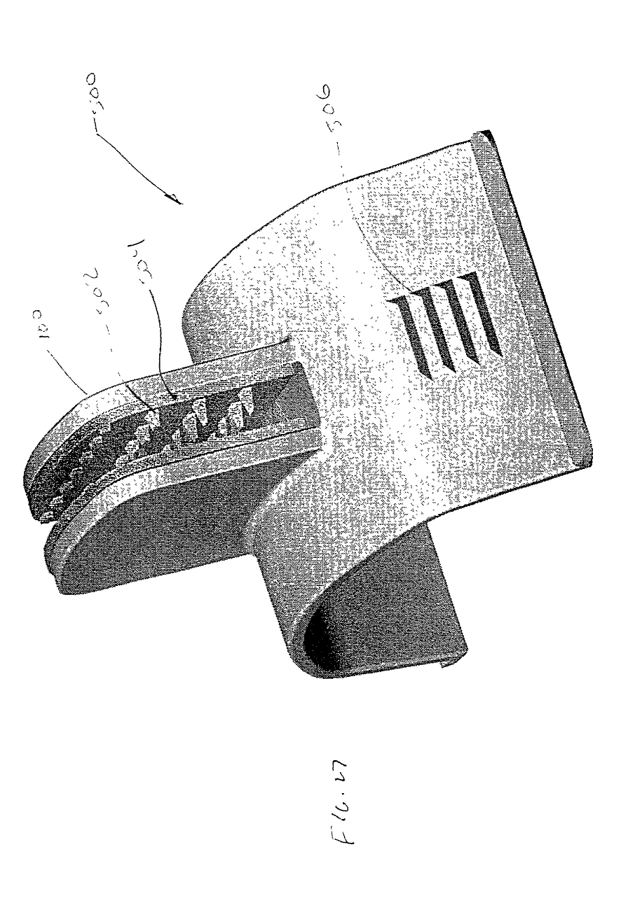

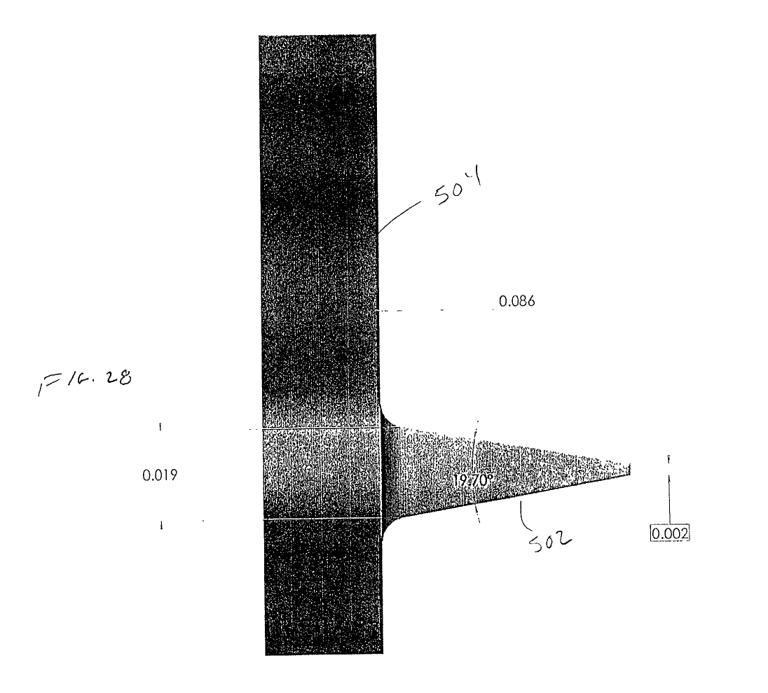

FIGS. 18-24 show a second embodiment clip 300. In this embodiment, the resilient protrusions are continuous from one edge of the wall portion to the opposite edge of the wall portion. The quantity, angle, size, profile, spacing, and length of the protrusions can be varied to produce a desired gripping strength. The protrusions can be arranged to form straight lines, V's, waves, and other configurations. The arrangement of the protrusions helps resist removal of the card by both horizontal and vertical forces. Horizontal forces are forces that tend to pull the card out of the opening perpendicular to the base and vertical forces are forces that tend to pull the card out of the opening parallel with the base.

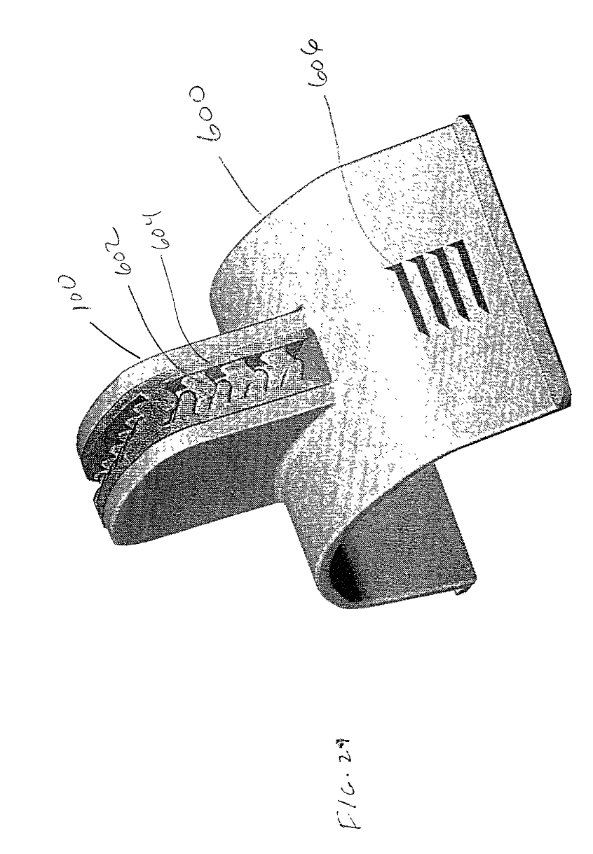

FIG. 25 shows a third embodiment clip 400. The clip may have a rigid portion similar to rigid portion 100 and a resilient portion that comprises a plurality of individual protrusions 402 coupled to a web 404. The protrusions 402 may be arranged in an array. The array may be arranged parallel or not parallel with the opening. The protrusions 402 may be in the shape of a pyramid. The clip 400 is shown with a pair of finger grips 406. The finger grips 406 can be co-injection molded with the same material as the protrusion 402 and the web 404. FIG. 26 shows detail of the protrusions 402.

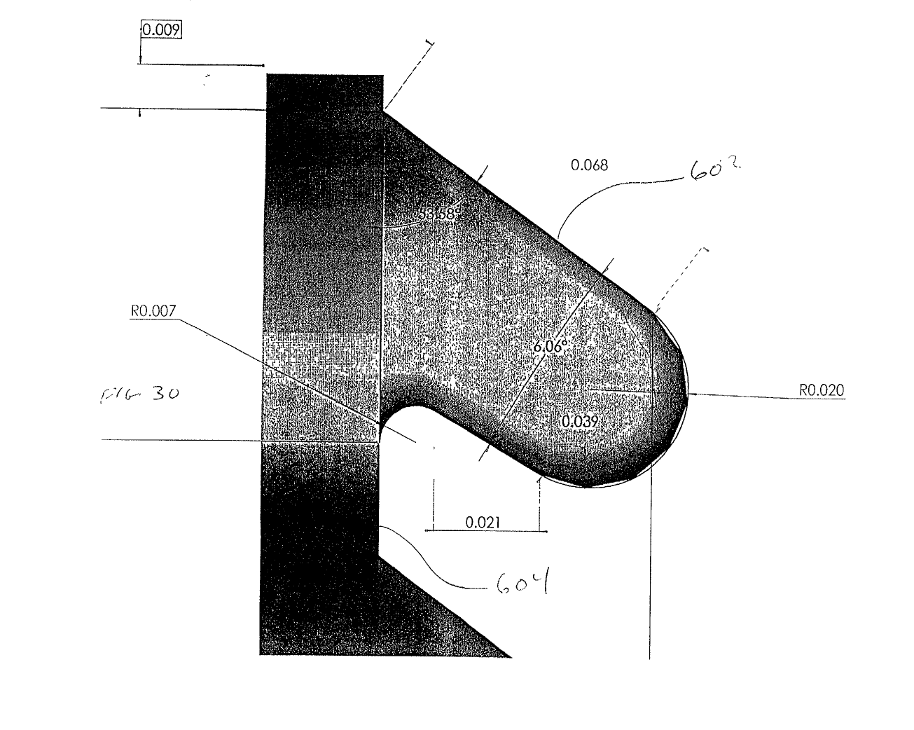

FIG. 27 shows a fourth embodiment clip 500. The clip may have a rigid portion similar to rigid portion 100 and a resilient portion that comprises a plurality of individual protrusions 502 coupled to a web 504. The protrusions 502 may be arranged in an array. The protrusions 502 may be in the shape of a wedge. FIG. 28 shows detail of the protrusions 502.

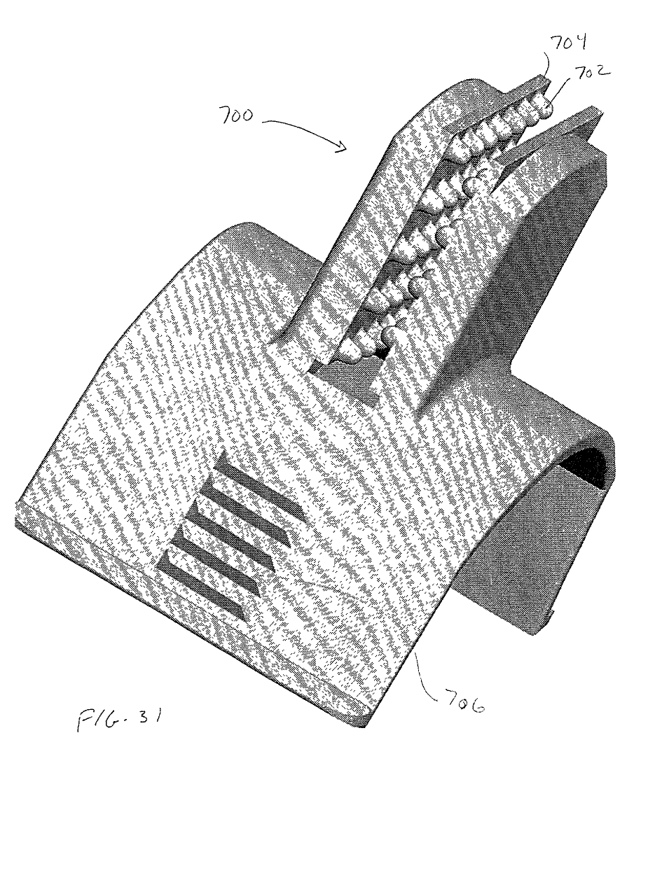

FIG. 29 shows a fifth embodiment clip 600. The clip may have a rigid portion similar to rigid portion 100 and a resilient portion that comprises a plurality of individual protrusions 602 coupled to a web 604. The protrusions 602 may be arranged in an array. FIG. 30 shows detail of the protrusions 602.

FIG. 31 shows a sixth embodiment clip 700. The clip may have a rigid portion similar to rigid portion 100 and a resilient portion that comprises a plurality of individual protrusions 702 coupled to a web 704. The protrusions 702 may be arranged in an array. The protrusions 702 may be in the shape of a bubble.

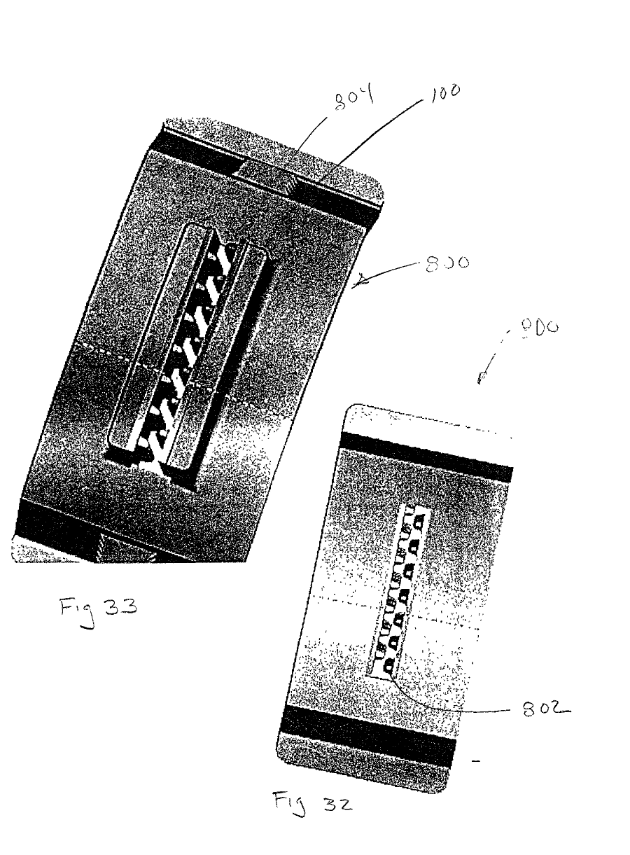

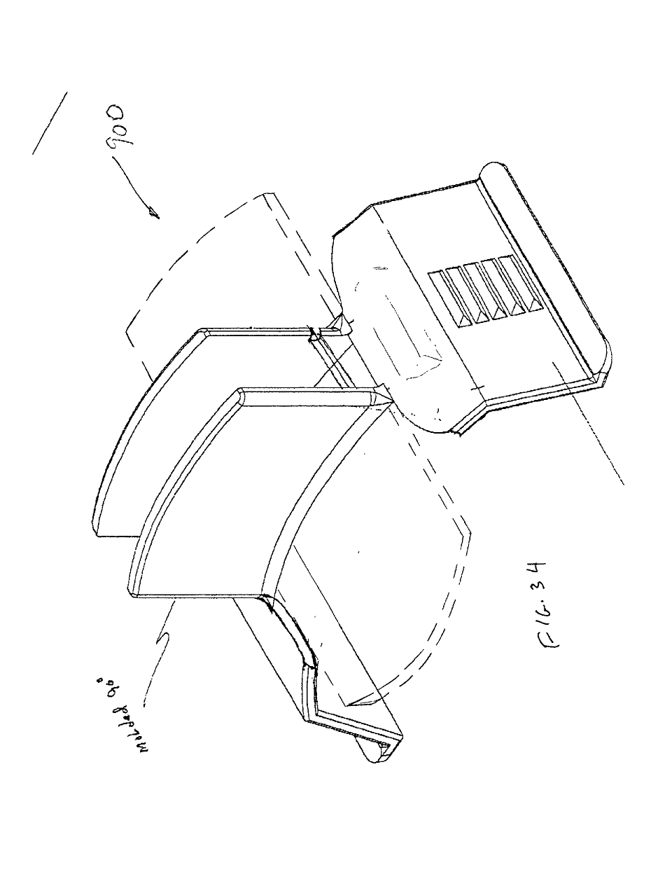

FIGS. 32 and 33 show a seventh embodiment clip 800. The clip may have a rigid portion similar to rigid portion 100 and a resilient portion that comprises a plurality of protrusions 802 coupled to a web 804. The protrusions 802 are shown arranged in a series of columns perpendicular to the opening.

As shown in FIG. 34, a second embodiment of a rigid portion 900 of a clip may be molded in a first position, in which the wall portions are not parallel, and then cured in a parallel position. Rigid portion 100 may be interchangeable with rigid portion 900 to form a clip.

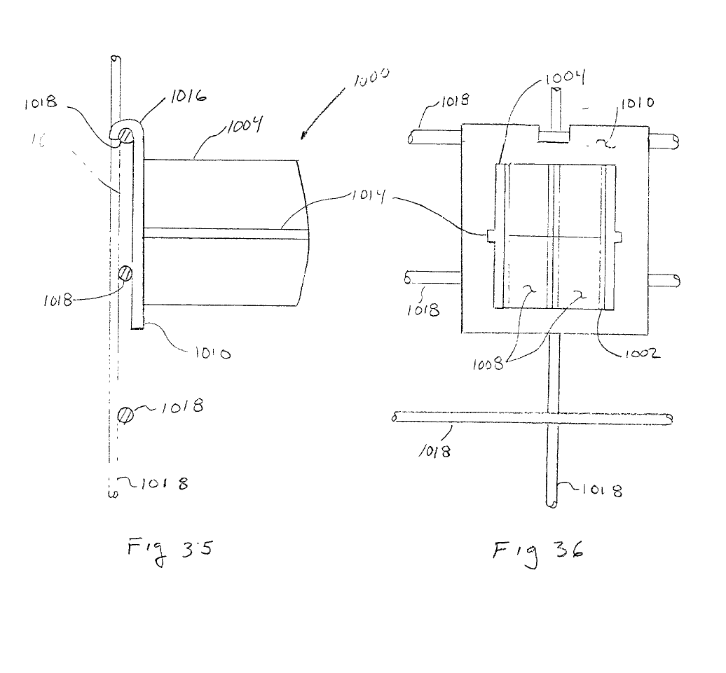

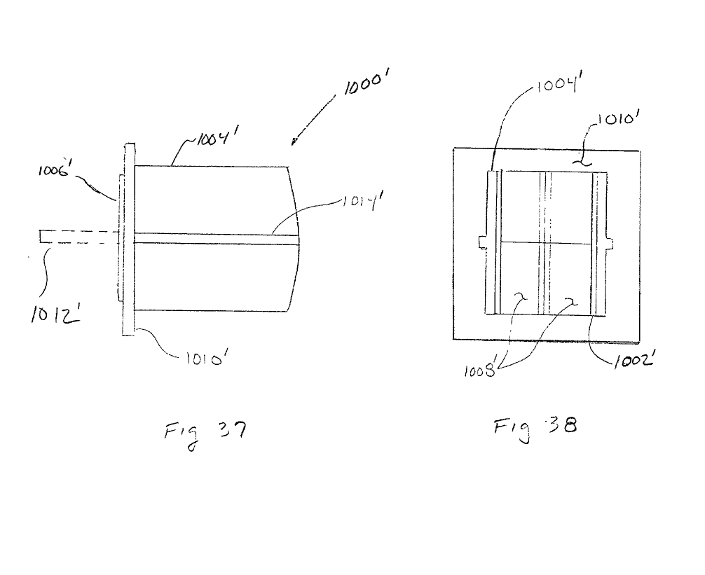

As shown in FIG. 35 and 36, an eighth embodiment clip 1000. The clip may have wall portions 1004, ribs 1014, protrusions 1008 coupled to a web 1002, and a base portion 1010. The base portion 1010 may be generally planar and include a hook 1016 that is capable of securement to a wire strand 1018.

As shown in FIG. 36 and 37, a ninth embodiment clip 1000′. The clip may have wall portions 1004′, ribs 1014′, protrusions 1008′ coupled to a web 1002′, and a base portion 1010′. The base portion 1010 may be generally planar and include an adhesive strip 1006′ on a rearward side for securing the clip to a shelf that does not include a molding track. The base portion 1010′ may alternatively include an integrally formed rearwardly extending ledge 1012′. The ledge capable of being positioned between stacked items such as boxes of goods to be sold.

The injection-molding process allows for inclusion of structural features in the present invention that would be impossible to manufacture by extrusion methods. For example, the wall portions may have one or more structural support ribs integral with the wall portions of the clip for increased strength and stronger gripping power. In the present invention, the resilient protrusions need not be continuous, nor must they run the length of the wall portion nor be parallel to the longitudinal axis of the wall portion. There are several preferred configurations of the resilient protrusions of the present invention, including staggered and discontinuous v-shaped gripping fins, which hold a display card more securely in all directions. The prior-art clipping means has linear longitudinal protrusions which only keep the display card from slipping in an upward direction perpendicular to the linear longitudinal protrusions. The v-shaped gripping fins of the present invention provide increased overall length of the resilient protrusions, which also provides better gripping. Such a configuration of the protrusions would be impossible to produce by extrusion. Other embodiments of the improved clip include resilient protrusions that are continuous, chevron-shaped fins or pyramidal, rectangular, wedge, and bubble-shaped protrusions.

Injection-molded clips inherently have a more consistent part tolerance, producing more consistency from part to part than does extrusion. Unlike extrusion, there is no die cutting involved to increase the possibility of breakage or of building stress into the part. The one-piece construction not only lowers manufacturing costs, but also makes for a much more structurally sound clip. Injection molding of the improved clip allows the possibility of more advantageous shapes, included curved lines and rounded edges. Thus, lower manufacturing costs, improved strength, reduced possibility of breakage, and several improved design features are important advantages over prior-art clips. Instead of co-injection molding the resilient portion and the rigid portion, the portions can be molded separately and then bonded together in a secondary step.

Other modifications and variations of the present invention are possible in light of the above teaching. It is, therefore, to be understood that within the scope of the appended claims, the invention may be practiced otherwise than literally described, but fall within the scope therein.

1. A clip for receiving and gripping a card, comprising;
a base portion comprising flanges for engaging in channels of a molding track of a shelf,
a plurality of wall portions coupled to the base portion, the wall portions spaced apart for placement of a card therebetween, the spaced wall portions forming an opening for the insertion of the card, and
a plurality of protrusions coupled to an inner surface of each of the wall portions, the protrusions extending into the space between the wall portions for griping an inserted card, the protrusions being arranged to run non-parallel with the opening.

2. The clip of claim 1, wherein the base portion is sufficiently flexible to afford engagement of the flanges in the molding track when the flanges are depressed inwardly.

3. The clip of claim 1, wherein the clip is injection, compression, or transfer molded.

4. The clip of claim 1, wherein a durometer reading of the protrusions is less than a durometer reading of the base.

5. The clip of claim 1, wherein the protrusions and the base are integrally molded.

6. The clip of claim 1, wherein protrusions comprise a plastic selected from the group consisting of a thermoplastic elastomer and a thermoplastic polyurethane elastomer, and the wall portions and the base portion comprise a rigid thermoplastic.

7. The clip of claim 1, wherein the base portion comprises a grip portion.

8. The clip of claim 1, wherein the wall portions are substantially parallel.

9. A clip for receiving and gripping a card, comprising;
a base portion comprising flanges for engaging in channels of a molding track of a shelf,
a plurality of wall portions coupled to the base portion, the wall portions spaced apart for placement of a card therebetween, the spaced wall portions forming an opening for the insertion of the card, and
a plurality of protrusions coupled to an inner surface of each of the wall portions, the protrusions extending into the space between the wall portions for gripping an inserted card, the protrusions being arranged to run non-parallel with each other.

10. The clip of claim 9, wherein the base portion is sufficiently flexible to afford engagement of the flanges in the molding track when the flanges are depressed inwardly.

11. The clip of claim 9, wherein the clip is injection, compression, or transfer molded.

12. The clip of claim 9, wherein a durometer reading of the protrusions is less than a durometer reading of the base.

13. The clip of claim 9, wherein the protrusions and the base are integrally molded.

14. The clip of claim 9, wherein the protrusions comprise a plastic selected from the group consisting of a thermoplastic elastomer and a thermoplastic polyurethane elastomer, and the wall portions and the base portion comprise a rigid thermoplastic.

15. The clip of claim 9, wherein the base portion comprises a grip portion.

16. The clip of claim 9, wherein the wall portions are substantially parallel.

17. A clip for receiving and gripping a card, comprising;
a base portion comprising flanges for engaging in channels of a molding track of a shelf,
a plurality of wall portions coupled to the base portion, the wall portions spaced apart for placement of a card therebetween, the spaced wall portions forming an opening for the insertion of the card, and
a plurality of protrusions coupled to an inner face of each of the wall portions, the protrusions extending into the space between the wall portions for gripping an inserted card,
the base portion, the wall portions and the resilient protrusions being integrally molded.

18. The clip of claim 17, wherein the base portion is sufficiently flexible to afford engagement of the flanges in the molding track when the flanges are depressed inwardly.

19. The clip of claim 17, wherein a durometer reading of the protrusions is less than a durometer reading of the base.

20. The clip of claim 17, wherein the protrusions comprise a plastic selected from the group consisting of a thermoplastic elastomer and a thermoplastic polyurethane elastomer, and the wall portions and the base portion comprise a rigid thermoplastic.

21. The clip of claim 17, wherein the base portion comprises a grip portion.

22. The clip of claim 17, wherein the wall portions are substantially parallel.

23. A clip for receiving and gripping a card, comprising;
a mounting surface for securing the cardholder in a fixed location/position,
a plurality of wall portions coupled to the mounting surface, the wall portions spaced apart for placement of a card therebetween, the spaced wall portions forming an opening for the insertion of the card, and
a plurality of protrusions coupled to an inner surface of each of the wall portions, the protrusions extending into the space between the wall portions for gripping an inserted card, the protrusions arranged to run non-parallel with the opening.

24. The clip of claim 23, further comprising a hook coupled to the mounting surface to secure the clip to a wire strand.

25. The clip of claim 23, wherein the clip is injection, compression, or transfer molded.

26. The clip of claim 23, wherein a durometer reading of the protrusions is less than a durometer reading of the wall portions.

27. The clip of claim 23, wherein the protrusions and the wall portions are integrally molded.

28. The clip of claim 23, wherein the protrusions comprise a plastic selected from the group consisting of a thermoplastic elastomer and a thermoplastic polyurethane elastomer, and the wall portions and the mounting surface comprise a rigid thermoplastic.

29. The clip of claim 23, wherein the mounting surface further comprises a ledge portion perpendicular to the mounting surface.

30. The clip of claim 23, wherein the wall portions are substantially parallel.

31. The clip of claim 23, further comprising an adhesive to secure the clip to a shelf.
